(19) United States
(12) Patent Application Publication
(10) Pub. No.: US 2026/0225217 A1
(43) Pub. Date: Aug. 6, 2026

(54) Hand-held impact power tool with pressing force-adapted power regulation

(71) Applicant: Hilti Aktiengesellschaft, Schaan (LI)

(72) Inventors: Markus HARTMANN, Mauerstetten (DE); Florian HURKA, Margertshausen (DE); Steffen GEIGER, München (DE); Maryam EFTEKHARI, Untermeitingen (DE); Jasper WESSELINGH, KG Arnhem (NL); Michael UNSÖLD, Penzing (DE)

(21) Appl. No.: 19/147,779

(22) PCT Filed: Jan. 5, 2024
(86) PCT No.: PCT/EP2024/050185

§ 371 Date: Jul. 14, 2025

(30) Foreign Application Priority Data
Jan. 19, 2023 (EP) 23152332.5

(51) Int. Cl. B25D 17/04

(52) U.S. Cl. CPC B25D 17/043; B25D 2250/095; B25D 2250/221

(57) ABSTRACT

A hand-held impact power tool having an electric motor drive unit for generating a rotary drive movement, which converts a subsequent impact mechanism unit into an alternating linear impact movement, which impacts a percussion drill or chisel hammer releasably locked in a subsequent tool receiving unit. A housing assembly composed of an outer housing with a handle and a base housing resiliently mounted in the impact force direction accommodates the impact mechanism unit, wherein an electronic control unit is also provided for the pressing force-adapted power regulation of the electric motor drive unit based on a current pressing force determined by means of a sensor on the percussion drill or chisel hammer when machining a workpiece, wherein the sensor is arranged on an electronic circuit board that at least partially forms the electronic control unit and is accommodated within the outer housing in such a way that the sensor is positioned adjacent to a detection element arranged on the base housing side.

### BACKGROUND

The field of application of the invention extends primarily to hand-held hammer drills or chisel hammers, which are provided with an electric motor drive unit. Such hand-held power tools generate a linear alternating working movement via a mechanical impact mechanism, i.e., a reciprocating movement for impacting the tool, which in the case of a chisel hammer is designed as a mortise chisel and in the case of a hammer drill as a percussion drill for machining preferably mineral materials, such as stone, concrete and the like. Due to the interaction with the workpiece and the hand-arm system of the operator as well as the internal mass and stiffness distribution, a hand-held power tool that can drive a tool to strike normally has complex vibration behavior that must be suppressed as far as possible.

### SUMMARY OF THE INVENTION

For this reason, composite housing assemblies of interest are used here, the outer housing of which is equipped with a handle molded thereon and is combined with a base housing mounted in a resilient manner. In the base housing, at least the impact mechanism unit is accommodated with the tool receiving unit attached thereto and extending from the base housing, and usually also the electric drive unit. This composite housing concept serves to reduce vibrations in that the working movement generated by the impact mechanism unit is not completely transmitted to the handle and thus to the operator, but is damped via the spring elements arranged between the housing elements.

Pressing force-adapted power regulation of the electric motor drive unit, which is usually brought about in addition thereto, causes the power of the drive unit to increase as the pressing force increases, which is carried out automatically via an electronic control unit.

The generally known prior art discloses hand-held impact power tools with pressing force-adapted impact performance which capture various concepts for detecting the pressing force of the tool on the workpiece currently exerted by an operator. In particular in the case of composite housing assemblies consisting of a base housing and an outer housing, which are pretensioned against one another by spring means, it is expedient to deduce the pressing force from the relative movement between the base housing and the outer housing with knowledge of the spring characteristic, for example by means of a displacement sensor system.

In known sensor assemblies for detecting this relative movement, both the sensor and the detection element corresponding thereto are usually arranged as individual components in the hand-held power tool. The sensor is associated with electronics for processing measurement data and forwarding said data in digital or analog form to the electronic control unit of the hand-held power tool.

DE 10 2012 005 803 A1 discloses a generic hand-held impact power tool which has an impact mechanism unit driven by a drive unit and a handle for an operator formed on the housing. A force detection device can detect the pressing force of the operator on the handle. If a predetermined working impact force limit value is exceeded by the detected pressing force, the impact frequency of the impact mechanism can be increased to a predetermined working frequency. If the detected pressing force of the operator falls below a predetermined idle impact force limit, the impact frequency can be reduced to a predetermined idle speed. For this purpose, the force detection device has a force sensor arranged in the flow of force between a contact surface provided on the holding device for the operator's hand on the one hand and the drive unit and/or the impact mechanism unit and/or the tool receiving unit on the other hand, and generates a signal as a function of the pressing force of the operator. The force sensor is preferably a displacement sensor with which a relative movement of the handle relative to the drive unit and/or the impact mechanism unit can be detected, wherein the relative movement depends on the pressing force of the operator.

Furthermore, DE 197 38 092 C1 discloses pressure force-adapted power regulation for a hand-held impact power tool, the force sensor of which is arranged directly under a housing portion formed on the handle. The sensor surface of the force sensor faces the casing which has thinner walls in the region of the force sensor than the housing portion surrounding this region. A signal from the force sensor corresponding to an actuating force is detected by the electronic control unit and, if constant, the operating parameters corresponding to this actuating force are automatically maintained over a selectable period of time. The effective range of the force sensor can be preset to influence the operating parameters using an adjusting wheel associated with the electronic control unit.

All these sensor concepts of the prior art prove to be relatively complex and/or error-prone, in particular with regard to data lines running between a sensor and the electronic control unit, which are exposed to interfering magnetic fields of the drive unit and the like.

It is an object of the present invention to further improve a hand-help impact power tool with pressing force-adapted power regulation of the generic type in such a way that a simple design with reduced susceptibility to faults is achieved.

The present invention provides a hand-held impact power tool, preferably a hammer drill or chisel hammer, having an electric motor drive unit (4) for generating a rotary drive movement, which converts a subsequent impact mechanism unit (5) into an alternating linear impact movement, which impacts a percussion drill or chisel hammer (8) that is releasably locked in a subsequent tool receiving unit (6), wherein a housing assembly composed of an outer housing (1) with a handle (2) and a base housing (3) resiliently mounted in the impact force direction (FA) is provided for accommodating at least the impact mechanism unit (5), wherein an electronic control unit (10) is also provided for the pressing force-adapted power regulation of the electric motor drive unit (4) based on a current pressing force determined by means of a sensor (11, 11′, 11″) on the percussion drill or chisel hammer (8) when machining a workpiece, characterized in that the sensor (11, 11′, 11″) is arranged on an electronic circuit board (12, 12′, 12″, 12′″, 12″″) that at least partially forms the electronic control unit (10) and is accommodated within the outer housing (1) in such a way that the sensor (11) is positioned adjacent to a detection element (13, 13′, 13″) arranged on the base housing (3) side.

The invention incorporates the technical principle that a pressing force-adapted power regulation sensor is arranged directly on an electrical circuit board which at least partially forms the electronic control unit and is accommodated within the outer housing of a composite housing assembly in such a way that the sensor is positioned adjacent to a detection element arranged on the base housing side, namely in its sensor-effective range.

Advantageously, the complexity of the pressing force-adapted power regulation is reduced by placing the electronic circuit board of the electronic control unit in the hand-help power tool in such a way that the sensor is integrated directly on the electronic circuit board. The electronic circuit board is arranged on the outer housing side and the detection element is located in the base housing. The electronic circuit board is to be mounted in the outer housing in such a way that the distance from the detection element on the base housing is as small as possible.

The electric motor drive unit adjacent to the sensor normally generates strong interference to data lines due to the constantly changing magnetic field of the motor. However, since the sensor according to the invention is arranged directly on the electronic circuit board, these interference fields can only cause very little interference to the data lines between the sensor and the electronic control unit, which is also at least partially arranged on the same electronic circuit board, because the length of the data lines is reduced to a minimum. This eliminates the need for complex shielding measures for such a data line. At the same time, manufacturing costs are significantly reduced because the sensor does not require any additional electronics, such as measuring amplifiers or converters, and no cable connection between the sensor and the electronic control unit. In addition to the pure cost of parts, additional assembly work for attachment and cable laying can be saved. This not only reduces the manufacturing effort, but also the mechanical robustness of the sensor concept of the pressing force-adapted power regulation, since additional data lines are always susceptible to mechanical damage given the prevailing high vibration level of hand-held impact power tools, which can lead to an interruption in device communication and thus to device failure, which is avoided by the solution according to the invention.

According to a first preferred embodiment of the invention, the electronic circuit board with the sensor is arranged on an upper side within the outer housing in such a way that the electronic circuit board runs parallel to but spaced from the impact axis. This arrangement is suitable for housing shapes which offer sufficient space on the upper side for accommodating the electronic circuit board.

According to a second preferred embodiment, it is proposed to arrange the electronic circuit board with the sensor on an intermediate space between the base housing and the outer housing in such a way that the electronic circuit board runs transversely to the impact axis. This arrangement is particularly suitable for housing designs that have a relatively large transverse extent.

According to a third preferred embodiment, it is proposed that the electronic circuit board with the sensor is arranged on an underside of the outer housing in such a way that the electronic circuit board runs parallel to but spaced from the impact axis. This arrangement is particularly suitable for housing shapes that accommodate a short motor. In addition, it is also conceivable to arrange the electronic circuit board with the sensor between the upper side and the underside, i.e., on the flank side of the outer housing, so that the electronic circuit board here also runs parallel to but spaced from the impact axis.

The sensor for detecting the relative movements between the base housing and the outer housing is preferably designed as a 3D magnetic field sensor. This type of sensor is able to detect changes in distance in both the longitudinal and transverse directions and is therefore equally suitable for all installation positions of the electronic circuit board. A permanent magnet element can be used as the associated detection element, which permanent magnet element is attached to the base housing in the greatest possible proximity to the sensor.

Alternatively, the sensor can also be designed as an inductive sensor and the associated detection element can also be formed by metallic/magnetic component structures of the base housing or the components accommodated therein.

If the electronic control of the hand-held power tool is to be arranged distributed over multiple electronic circuit boards, at least one logic element of the electronic control unit is arranged on the electronic circuit board with the sensor, whereas the remaining power unit can be placed outside of the electronic circuit board in the outer housing or in the base housing of the hand-held power tool close to the drive. This measure increases the flexibility of accommodating electronic components in particularly compact housing shapes.

If there is sufficient installation space, an electronic control unit should preferably be provided that is arranged completely on the electronic circuit board in order to maximize the functional reliability of the electronics and reduce installation costs.

Preferably, the sensor should be soldered directly onto the electronic circuit board. This does not only refer to the establishment of the electrical connection of the sensor connections, but also to the sensor housing, which can therefore be reliably mounted on the electronic circuit board. The electronic circuit board itself can, for example, be releasably and therefore interchangeably attached on the inside of the outer housing via a conventional screw connection on corresponding support structures.

### BRIEF DESCRIPTION OF THE DRAWINGS

Further measures improving the invention are explained in more detail below together with the description of preferred exemplary embodiments of the invention with reference to the figures. In the drawings:

FIG. 1 shows a schematic side view of a first embodiment of a hand-held impact power tool with pressing force-adapted power regulation according to the invention,

FIG. 2 shows a schematic side view of a second embodiment of a hand-held impact power tool with pressing force-adapted power regulation according to the invention,

FIG. 3 shows a schematic side view of a third embodiment of a hand-held impact power tool with pressing force-adapted power regulation according to the invention, and

FIG. 4 shows a schematic side view of a fourth embodiment of a hand-held impact power tool with pressing force-adapted power regulation according to the invention.

### DETAILED DESCRIPTION

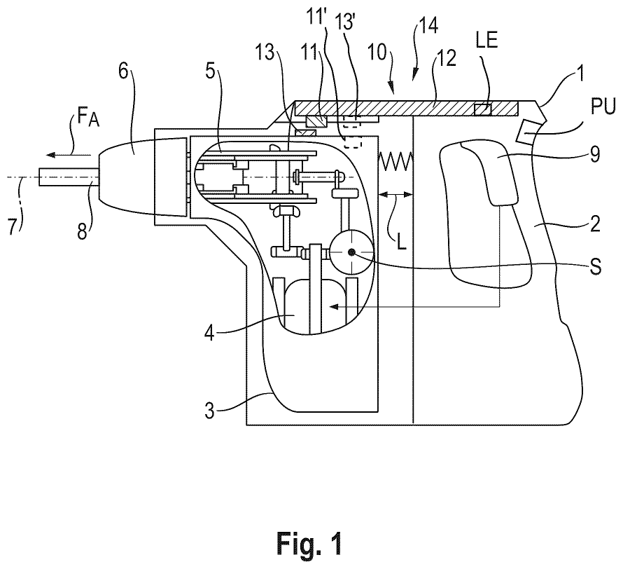

According to FIG. 1, a hammer drill has a composite housing assembly consisting of an outer housing 1 with a handle 2 and a base housing 3 which is resiliently mounted in the impact force direction F_{A}, in which an electric motor drive unit 4 and a subsequent impact mechanism unit 5 are accommodated, on which an outwardly projecting tool receiving unit 6 is arranged. A percussion drill 8 is releasably locked in the tool receiving unit 6 along an impact axis 7. While the impact mechanism unit 5, the tool receiving unit 6 and the percussion drill 8 lie on the common impact axis 7, the electric motor drive unit 4 is arranged transversely thereto and is connected to the impact mechanism unit 5 via gear means. The overall arrangement of the various functional units forms the center of gravity S.

A manually operable switch 9 for switching the electric motor drive unit 4 on and off is also arranged on the handle 2 of the outer housing 1, which switch is placed on the base housing 3 side. When the hand-held power tool is not operated, there is a distance L between the outer housing 1 and the base housing 3, which distance determines the spring stroke.

The hammer drill is equipped with an electronic control unit 10 for pressing force-adapted power regulation of the electric motor drive unit 4. A sensor 11 determines the distance between the outer housing 1 and the base housing 3, which is resiliently mounted in the impact force direction F_{A}, which, in a manner known per se, represents a measure of the pressing force currently exerted on the percussion drill 8 when machining a workpiece.

The sensor 11, designed here as a 3D magnetic field sensor, is fixedly arranged by soldering on an electronic circuit board 12 forming the electronic control unit 10. The electronic circuit board 12 with the sensor 11 is arranged on an upper side 14 within the outer housing 1 parallel to the impact axis 7 and positioned such that the sensor 11 is adjacent to a detection element 13 arranged on the base housing 3 side. The detection element 13 is designed as a permanent magnet element which is embedded in the wall of the base housing 3 close to the sensor 11.

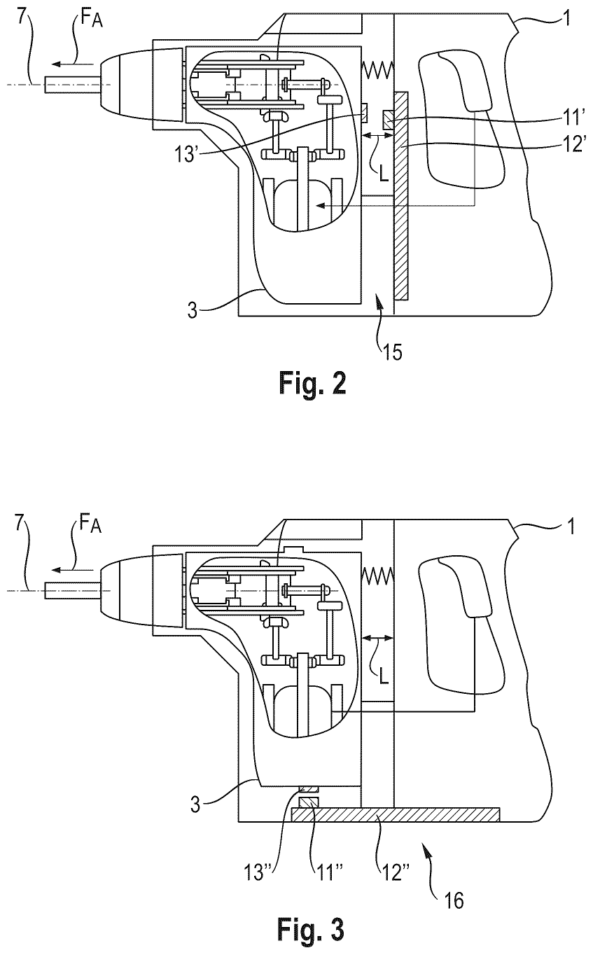

FIG. 2 shows an embodiment in which the electronic circuit board 12′ with a sensor 11′ attached thereto is arranged in an intermediate space 15 between the base housing 3 and the spring housing 1. The intermediate space 15 is formed by the spring travel of the vibration decoupling, which corresponds to the spring stroke L. The electronic circuit board 12′ runs transversely to the impact axis 7. The sensor 11′ arranged on the outer housing 1 side is positioned opposite the detection element 13′, wherein the two components, the sensor 11′ and the detection element 13′, do not come into contact with respect to the outer housing 1 even in the retracted end position of the base housing 3. The remaining structure of the hand-held power tool according to the second embodiment corresponds to the first embodiment described above.

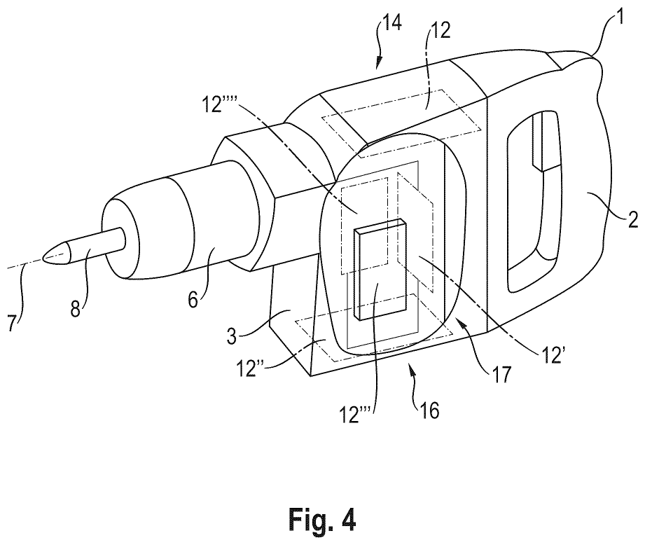

According to FIG. 3, in the third embodiment of a hand-held power tool, the electronic circuit board 12″ with the sensor 11″ is arranged on the inside on the underside 16 of the outer housing 1 in such a way that the electronic circuit board 12″ runs parallel to but spaced from the impact axis 7. This design is particularly suitable for short electric motors, since there is still enough space underneath them to arrange a sensor 11″ with the corresponding detection element 13″, which is positioned below the electric motor drive unit 4. Here too, the remaining components of the hand-held power tool correspond to the first embodiment.

According to the fourth embodiment illustrated in FIG. 4, the electronic circuit board 12′″ is arranged on the flank side 17 of the outer housing 1 running between the upper side 14 and the underside 16, so that the electronic circuit board 12′″ here also runs parallel to but spaced from the impact axis 7.

Alternatively, the electronic circuit board 12″″ can of course also be arranged on the inside of the housing on the flank side (without reference sign) opposite the flank side 17.

The drawing illustrates in one image all of the above-described options for a space-saving arrangement of the electronic circuit board 12, 12′, 12″, 12′″, 12″″ according to the invention.

The invention is not limited to the three exemplary embodiments described above. On the contrary, modifications thereof are also conceivable, which are encompassed by the scope of protection of the following claims. For example, it is also possible to use an inductive sensor (shown solely schematically in FIG. 1 as 13′ to sense a component structure 11′) instead of a 3D magnetic field sensor, provided that it can provide sufficiently reliable measurement values about the current distance situation between the outer housing 1 and the base housing 2 with regard to the installation position and detection environment. Also shown solely schematically is a logic element LE and power unit PU for distributed electronic circuit boards discussed above.

### LIST OF REFERENCE SIGNS

1 Outer housing
2 Handle
3 Base housing
4 Drive unit
5 Impact mechanism unit
6 Tool receiving unit
7 Impact axis
8 Percussion drill or chisel hammer
9 Switch
10 Electronic control unit
11 Sensor
12 Electronic circuit board
13 Detection element
14 Upper side
15 Intermediate space
16 Underside
17 Flank side
F_{A} Impact force direction
S Center of gravity
L Distance
LE Logic Element
PU Power Unit

What is claimed is:

1.-11. (canceled)

12. A hand-held impact power tool comprising:
an electric motor drive for generating a rotary drive movement, the electric motor drive converting a subsequent impact mechanism into an alternating linear impact movement impacting a percussion drill or chisel hammer releasably locked in a subsequent tool receiver;
a housing assembly composed of an outer housing with a handle and a base housing resiliently mounted in an impact force direction, the base housing for accommodating at least the impact mechanism;
an electronic control unit for pressing force-adapted power regulation of the electric motor drive based on a current pressing force determined by a sensor on the percussion drill or chisel hammer when machining a workpiece;
the sensor being arranged on an electronic circuit board at least partially forming the electronic control unit, the sensor being accommodated within the outer housing so that the sensor is positioned adjacent to a detector arranged on a side of the base housing.

13. The hand-held impact power tool as recited in claim 12 wherein the electronic circuit board with the sensor is arranged in an upper side of the outer housing so that the electronic circuit board runs parallel to but spaced from an impact axis.

14. The hand-held impact power tool as recited in claim 12 wherein the electronic circuit board with the sensor is arranged in or on an intermediate space between the base housing and the outer housing so that the electronic circuit board runs transversely to an impact axis.

15. The hand-held impact power tool as recited in claim 12 wherein the electronic circuit board with the sensor is arranged on an underside of the outer housing so that the electronic circuit board runs parallel to but spaced from an impact axis.

16. The hand-held impact power tool as recited in claim 12 wherein the electronic circuit board with the sensor is arranged on one of two flank sides of the outer housing running between the upper side and the underside in such a way that the electronic circuit board runs parallel to but spaced from an impact axis.

17. The hand-held impact power tool as recited in claim 12 wherein the sensor is designed as a 3D magnetic field sensor and the detector is designed as a permanent magnet.

18. The hand-held impact power tool as recited in claim 12 wherein the sensor is designed as an inductive sensor and the detector is formed by a component structure of or accommodated in the base housing.

19. The hand-held impact power tool as recited in claim 12 wherein the electric motor drive is accommodated in the base housing.

20. The hand-held impact power tool as recited in claim 12 wherein a logic element of the electronic control unit is arranged on the electronic circuit board and a power unit is accommodated outside of the electronic circuit board in the outer housing or in the base housing.

21. The hand-held impact power tool as recited in claim 12 wherein the electronic control unit is arranged completely on the electronic circuit board of the outer housing.

22. The hand-held impact power tool as recited in claim 12 wherein the sensor is fixedly attached to the electronic circuit board by soldering.

23. A hammer drill or chisel hammer comprising the hand-held impact power tool as recited in claim 12.
